(19) United States
(12) Patent Application Publication
(10) Pub. No.: US 2017/0055771 A1
(43) Pub. Date: Mar. 2, 2017

(54) RETRACTABLE BARBEQUE GRILL

(71) Applicant: Shou Qiang ZHU, Ontario, CA (US)

(72) Inventor: Shou Qiang ZHU, Ontario, CA (US)

(73) Assignee: IP POWER HOLDINGS LIMITED, Hong Kong (CN)

(21) Appl. No.: 15/247,782

(22) Filed: Aug. 25, 2016

Related U.S. Application Data
(60) Provisional application No. 62/209,683, filed on Aug. 25, 2015.

(51) Int. Cl. A47J 37/07

(52) U.S. Cl. CPC A47J 37/0781; A47J 2037/0777; A47J 2037/0795

(57) ABSTRACT

A barbeque (BBQ) grill set may include a top surface, a pair of front doors, a pair of side tables, and a main frame. The top surface is disposed at a top portion of the main frame, while the front doors are disposed at a front end of the main frame, and a BBQ grill unit secured on a base is received in a receiving space. In one embodiment, the top surface is pivotally connected to the side tables and the base. When the top surface is lifted, the side tables on both sides of the main frame are moving upwards, as well as the base. When the top surface is totally lifted, the base and the side tables will all be disposed at the same horizontal surface, and the BBQ grill unit is protruding out from a top opening of the frame and ready for the user to use.

### CROSS-REFERENCE TO RELATED APPLICATIONS

This application claims priority under 35 U.S.C. §119(e) to U.S. Provisional Patent Application Ser. No. 62/209,683, filed on Aug. 25, 2015, the entire contents of which are hereby incorporated by reference.

### FIELD OF THE INVENTION

The present invention is related to a barbeque (BBQ) grill, and in particular to a retractable BBQ grill, in which the grill can be protected and received in a receiving space of a BBQ grill set.

### BACKGROUND OF THE INVENTION

The grilling of food is a popular method of food preparation, particularly in a recreational setting. Outdoor grilling is particularly popular during summer time as a way to avoid introducing additional heat into an interior of a living environment as well as itself being a recreational activity. Furthermore, outdoor grilling is often done at parks and campgrounds since it is a convenient means of food preparation at locations that are away from normal residential areas.

A wide variety of different shapes and configurations are used for barbecue grills and outdoor cooking systems. U.S. Pat. No. 7,284,549 discloses a portable grill that includes a grill body and support stand that may be removably mounted on a wall and alternatively supported on a horizontal surface such as the ground or a table using the same support stand. A cutting board is selectively interchangeable with the grill body on the support stand. The grill may vulnerable to external environmental conditions such as cold/hot weather, rain, moisture, etc. so it may have to be stored inside to avoid being adversely affected by such conditions. However, it may not be appropriate to store an outdoor cooking apparatus like a BBQ grill inside the house.

U.S. Pat. Pub. No.: 2012/0138043 to Spangrud discloses a handle for a barbeque grill lid having a first end and an opposing second end which are connected to the lid, as shown in FIG. 1. The handle has an intermediate portion between the first and second ends. The intermediate portion has a slot formed in the exterior surface thereof at the side facing away from the lid. The slot reduces the cross-sectional area of the handle, reducing heat transfer from the lid through the handle while at the same time increasing the external surface area of the handle, increasing air cooling of the handle. The grill disclosed by Spangrud is not portable so it has to stay outside and may be vulnerable to external environmental conditions as discussed above.

Therefore, there remains a need for a new and improved BBQ grill set that is portable and can be arranged to stay outside the house, but will not be adversely affected by external environmental conditions.

### SUMMARY OF THE INVENTION

It is an object of the present invention to provide a retractable barbeque (BBQ) grill set that is portable and can be arranged to stay outside the house, but will not be adversely affected by external environmental conditions.

It is another object of the present invention to provide a retractable BBQ grill set that is easy to set up by simply lifting the top cover of the BBQ grill set.

It is a further object of the present invention to provide a retractable BBQ grill set that is easy to restore when not in use by simply pushing down the top cover of the BBQ grill set.

In one aspect, a barbeque (BBQ) grill set may include a top surface, a pair of front doors, a pair of side tables, a main frame and a BBQ grill unit. The top surface is disposed at a top portion of the main frame, while the front doors are pivotally connected to a front portion of the main frame, and the BBQ grill unit secured on a base is received in a receiving space inside the main frame.

In one embodiment, the top surface is operatively connected to the side tables, and the side tables are pivotally connected to a supporting assembly that is pivotally connected to the base, so when the top surface is lifted, the side tables on both sides of the main frame are moving upwards, as well as the base. When the top surface is totally lifted, the base and the side tables will all be reached to the same horizontal level as a top opening of the main frame. Meanwhile, the BBQ grill unit secured on top of the base is protruding out from the top opening of the frame and ready for the user to use.

Each of the side tables is supported by a supporting assembly, which includes a first supporting rod, one end of which is pivotally connected to the bottom portion of the side table, and the other end is pivotally connected to a supporting frame which diagonally traverses an upper portion of a first side opening of the main frame. One end of the supporting frame is pivotally connected to one side of the base, and the other end thereof is slidably connected to a rail located at a rear portion of the receiving space. Thus, the movement of the side table can trigger the movement of the supporting frame which moves along a rail, and since one end of the supporting frame is pivotally connected to the base, the movement of the supporting frame can further trigger the movement of the BBQ grill unit secured on top of the base.

The supporting assembly further includes a second supporting rod connected to a lower portion of the supporting frame. The second supporting rod 364 may have a first portion and a second portion, which are telescopically connected together. In one embodiment, a hydraulic or pneumatic pressure can be applied to the second portion of the second supporting rod to support a heavier object like the BBQ grill unit.

The BBQ grill set in the present invention can be easily restored to its original compact size. The user can simply push down the top surface to drive down the side tables as well as the first supporting rod, to simultaneously push down the supporting frame. Since one end of the supporting frame is connected to the base, the downward movement of the supporting frame will also bring the base down, as well the BBQ grill unit. Furthermore, since the second supporting rod can be either hydraulic or pneumatic, it is configured to sustain a much heavier object such as the BBQ grill unit, so the BBQ grill unit can be gradually moved down and eventually stored into the receiving space. The top surface can then be used to cover and protect the BBQ grill unit from being damaged.

Comparing with conventional outdoor BBQ grills, the present invention is advantageous because the BBQ grill unit can be received in the receiving space when it is not in use, so it can be protected from being damaged by external environmental conditions such as cold/hot weather, rain, moisture, etc. Furthermore, the BBQ grill unit can be easily set up by simply lifting the top surface all the way up, and restored by simply pushing down the top surface. Moreover, when the BBQ grill set is not in use, the size of the BBQ grill set does not occupy too much space because the BBQ grill unit is received in the receiving space and two side tables are bent down.

### BRIEF DESCRIPTION OF THE DRAWINGS

FIG. 1 illustrates a prior art disclosing a BBQ grill with a handle including a slot to reduce the cross-sectional area of the handle, reducing heat transfer from the lid through the handle while at the same time increasing the external surface area of the handle, increasing air cooling of the handle.

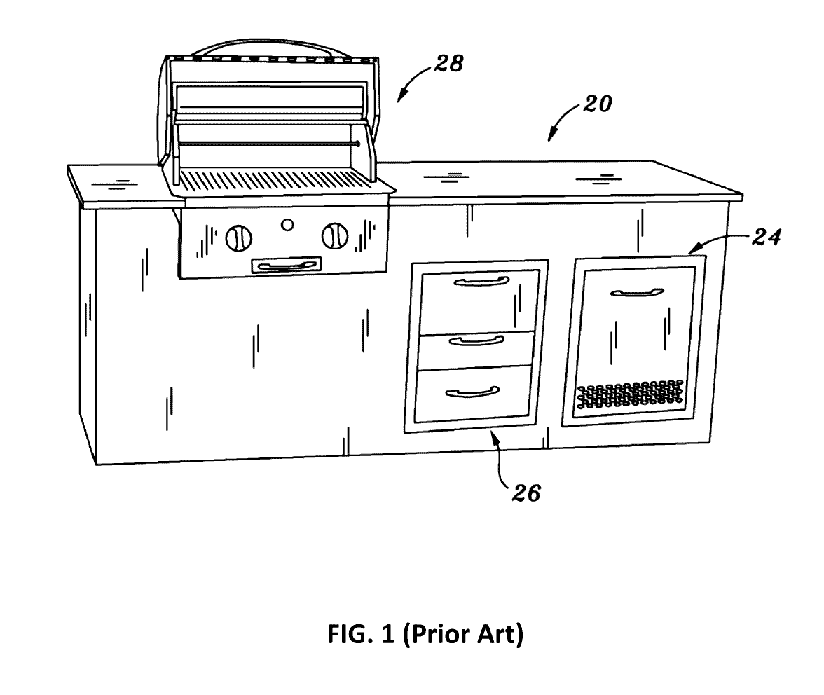

FIG. 2 illustrates a schematic view of the retractable BBQ grill in the present invention.

FIG. 3 illustrates a schematic view of the retractable BBQ grill having a receiving space to store the grill in the present invention.

FIG. 4 illustrates a schematic view of the retractable BBQ grill in the present invention when the top surface is lifted.

FIG. 5 illustrates a schematic view of the retractable BBQ grill in the present invention when the top surface is fully lifted and grill is ready for use.

FIG. 6 illustrates a schematic view of the supporting assembly in the present invention.

FIG. 7 illustrates a schematic view of the retractable BBQ grill in the present invention when the grill moves back to the receiving space.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

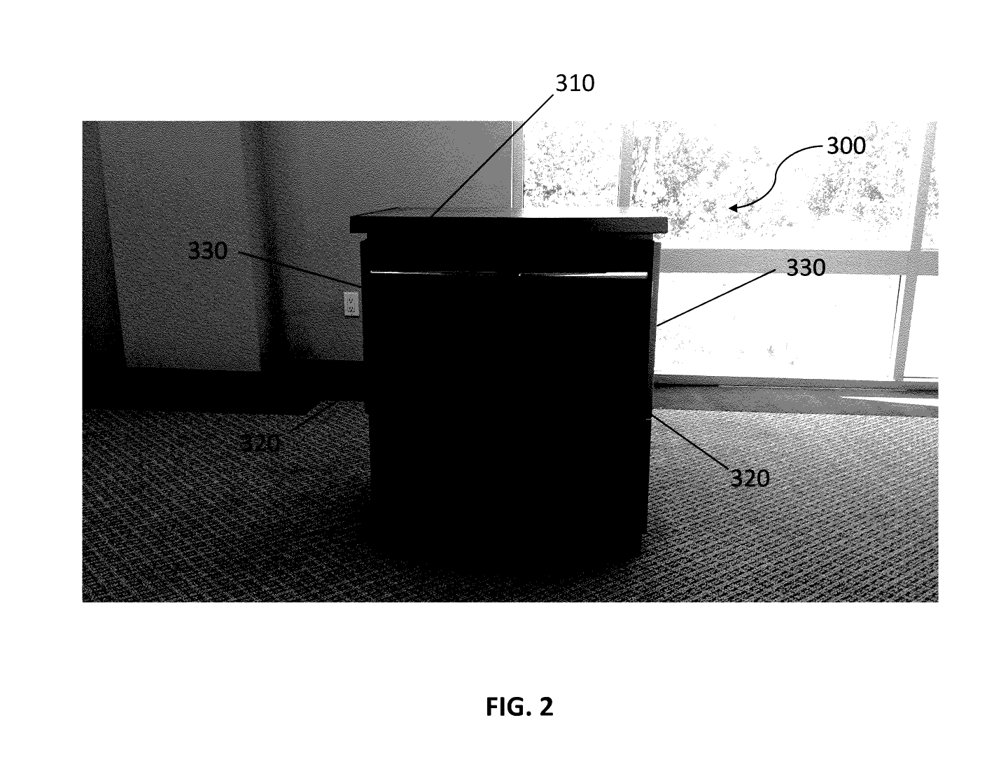

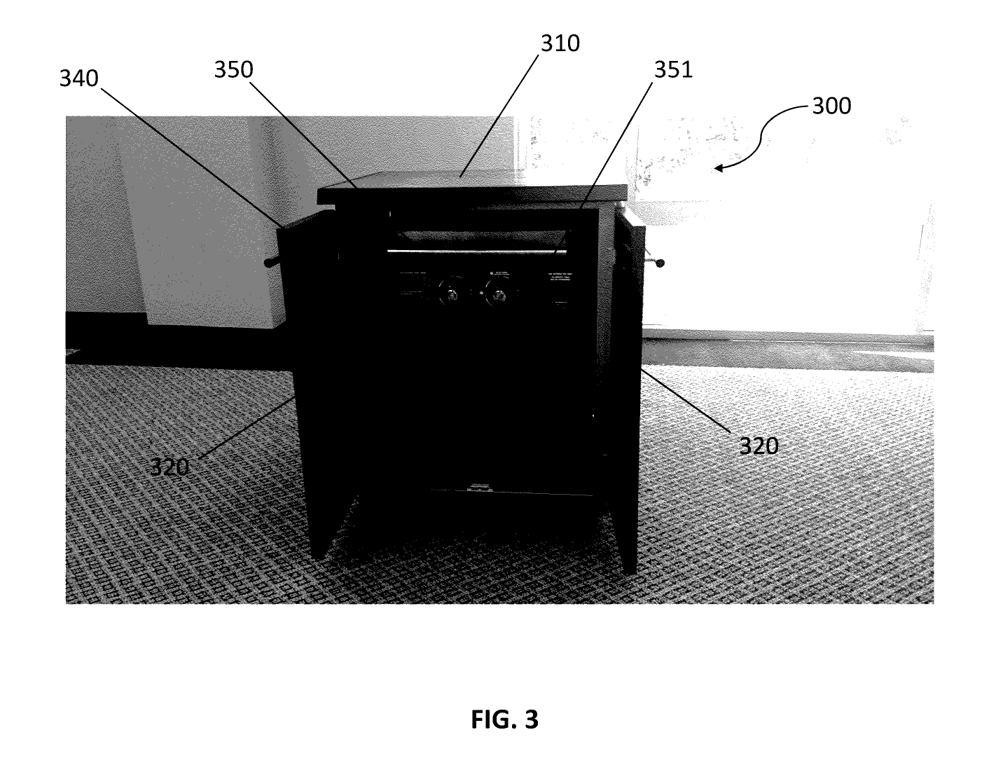

In one aspect, a barbeque (BBQ) grill set 300 may include a top surface 310, a pair of front doors 320, a pair of side tables 330, a main frame 340 and a BBQ grill unit 350. The top surface 310 is disposed at a top portion of the main frame 340, while the front doors 320 are pivotally connected to a front portion of the main frame 340, and the BBQ grill unit 350 secured on a base 351 is received in a receiving space 341 inside the main frame 340, as shown in FIGS. 2 and 3.

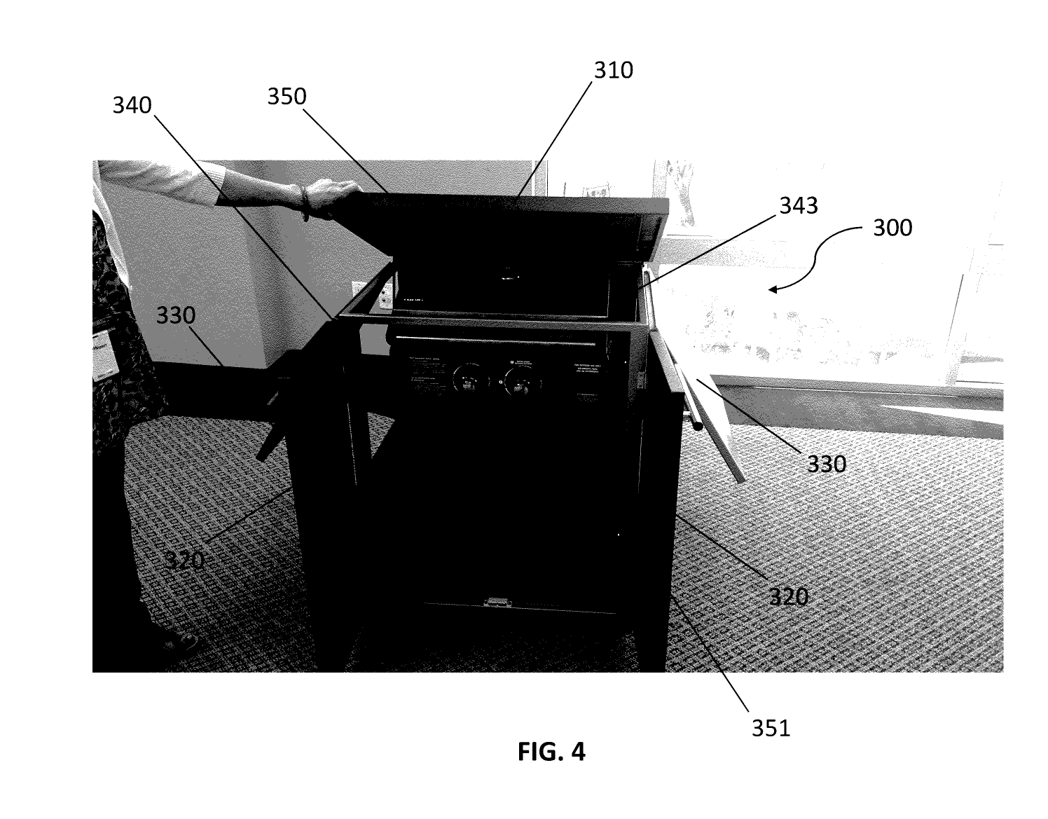

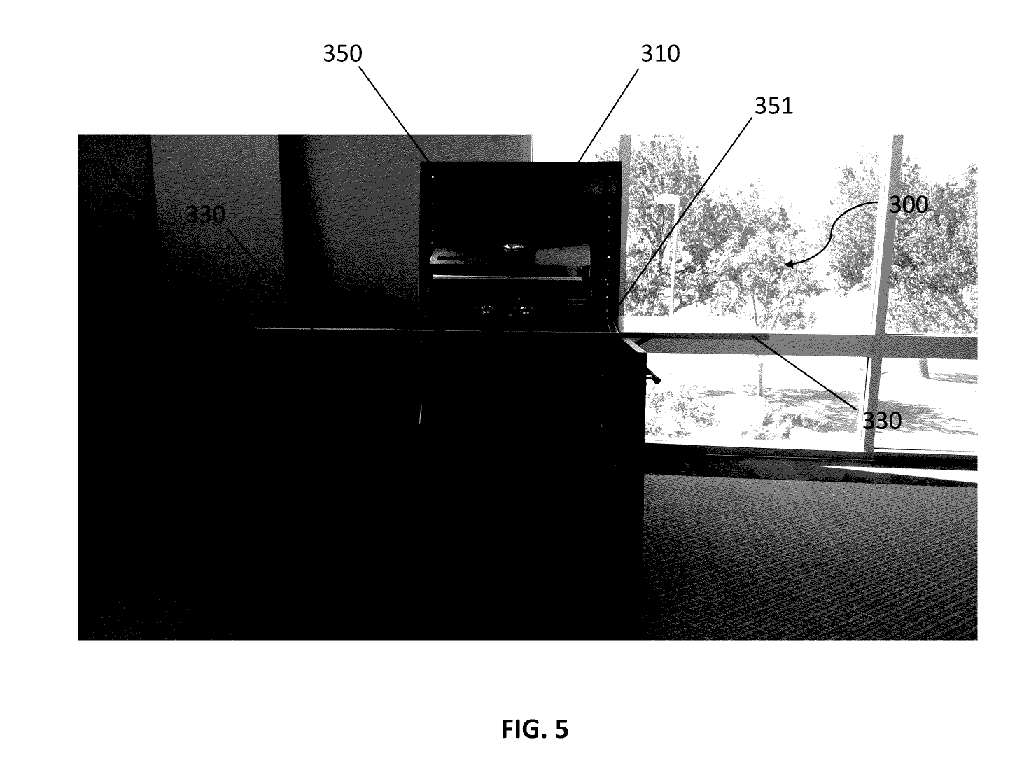

In one embodiment, the top surface 310 is operatively connected to the side tables 330, and the side tables are pivotally connected to a supporting assembly 360 that is pivotally connected to the base 351, so when the top surface 310 is lifted, the side tables 330 on both sides of the main frame 340 are moving upwards, as well as the base 351 as shown in FIG. 4. When the top surface 310 is totally lifted, the base 351 and the side tables 330 will all be reached to the same horizontal level as a top opening 343 of the main frame 340. Meanwhile, the BBQ grill unit 350 secured on top of the base 351 is protruding out from the top opening 343 of the frame 340 and ready for the user to use as shown in FIG. 5.

Each of the side tables 330 is supported by and pivotally connected to the supporting assembly 360, which includes a first supporting rod 361, one end of which is pivotally connected to the bottom portion of the side table 330, and the other end is pivotally connected to a supporting frame 362 which diagonally traverses an upper portion of a first side opening 344 of the main frame 340. One end of the supporting frame 362 is pivotally connected to one side of the base 351, and the other end thereof is slidably connected to a rail 363 located at a rear portion of the receiving space 341. Thus, the movement of the side table 330 can trigger the movement of the supporting frame 362 which moves along a rail 363, and since one end of the supporting frame 362 is pivotally connected to the base 351, the movement of the supporting frame 362 can further trigger the movement of the BBQ grill unit 350 secured on top of the base 351.

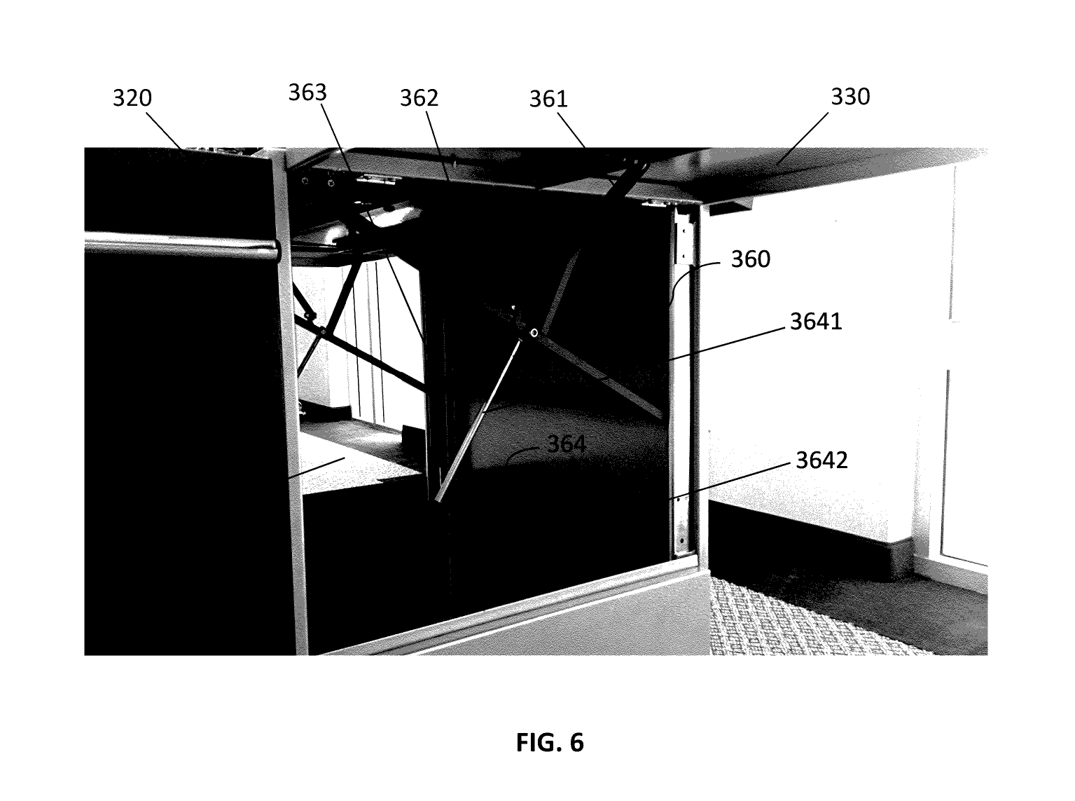

The supporting assembly 360 further includes a second supporting rod 364 connected to a lower portion of the supporting frame 342. The second supporting rod 364 may have a first portion 3641 and a second portion 3642, which are telescopically connected together as shown in FIG. 6. In one embodiment, a hydraulic or pneumatic pressure can be applied to the second portion 3642 of the second supporting rod 364 to support a heavier object like the BBQ grill unit 350.

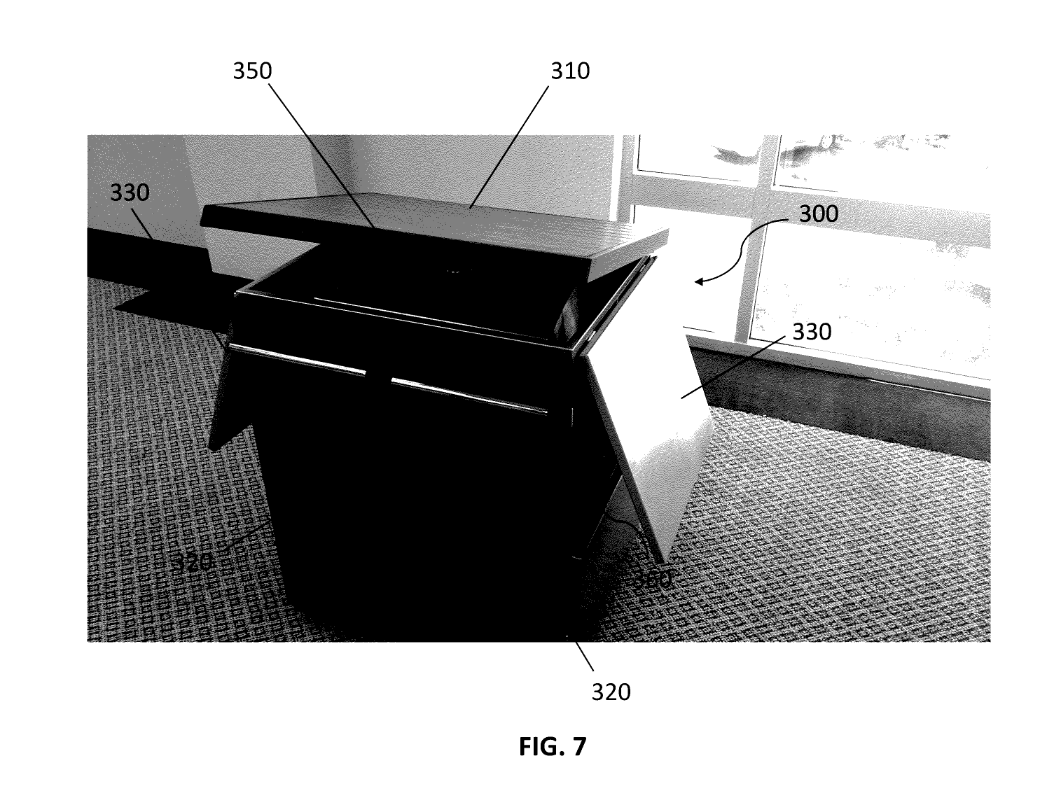

The BBQ grill set in the present invention can be easily restored to its original compact size. The user can simply push down the top surface 310 to drive down the side tables 330 as well as the first supporting rod 361, to simultaneously push down the supporting frame 342. Since one end of the supporting frame 342 is connected to the base 351, the downward movement of the supporting frame 342 will also bring the base 351 down, as well the BBQ grill unit 350. Furthermore, since the second supporting rod 364 can be either hydraulic or pneumatic, it is configured to sustain a much heavier object such as the BBQ grill unit 350, so the BBQ grill unit 350 can be gradually moved down and eventually stored into the receiving space 341, as shown in FIG. 7. The top surface 310 can then be used to cover and protect the BBQ grill unit 350 from being damaged.

Comparing with conventional outdoor BBQ grills, the present invention is advantageous because the BBQ grill unit 350 can be received in the receiving space 341 when it is not in use, so it can be protected from being damaged by external environmental conditions such as cold/hot weather, rain, moisture, etc. Furthermore, the BBQ grill unit 350 can be easily set up by simply lifting the top surface 310 all the way up, and restored by simply pushing down the top surface 310. Moreover, when the BBQ grill set 300 is not in use, the size of the BBQ grill set 300 does not occupy too much space because the BBQ grill unit 351 is received in the receiving space and two side tables 330 are bent down.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A barbeque (BBQ) grill assembly comprising:
a main frame;
a top surface located at a top portion of the main frame,
a pair of side tables operatively connected to the top surface and located at both sides of the top portion of the main frame; and
a BBQ grill unit secured on top of a base,
wherein the side tables are supported by and pivotally connected to a supporting assembly that is pivotally connected to the base, so when the top surface is lifted, the side tables on both sides of the main frame are moving upwards to simultaneously move up the base along with the BBQ grill unit until both the base and side tables reach a horizontal level as an top opening of the main frame.

2. The BBQ grill assembly of claim 1, further comprising a pair of doors pivotally connected to a front portion of the main frame.

3. The BBQ grill assembly of claim 1, wherein the BBQ grill unit secured on top of the base is protruding out from the top opening of the frame and ready for use when the top surface is fully lifted.

4. The BBQ grill assembly of claim 1, wherein the supporting assembly may include a first supporting rod, one end of which is pivotally connected to the bottom portion of the side table, and the other end is pivotally connected to a supporting frame, which diagonally traverses an upper portion of a first side opening of the main frame.

5. The BBQ grill assembly of claim 4, wherein one end of the supporting frame is pivotally connected to one side of the base, and the other end thereof is slidably connected to a rail located at a rear portion of the receiving space, so a movement of the supporting frame is configured to trigger a movement of the base.

6. The BBQ grill assembly of claim 5, wherein the supporting assembly further includes a second supporting rod connected to a lower portion of the supporting frame, and the second supporting rod have a first portion and a second portion, which are telescopically connected together.

7. The BBQ grill assembly of claim 6, wherein a hydraulic or pneumatic pressure is applied to the second portion of the second supporting rod to support the BBQ grill unit.
